(19) United States
(12) Patent Application Publication
(10) Pub. No.: US 2007/0050313 A1
(43) Pub. Date: Mar. 1, 2007

(54) Radio Frequency Identification tag for postal logistics processing apparatus and data configuration method thereof

(75) Inventors: Jeong-Hyun Park, Daejeon (KR); Jong-Heung Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics & Telecommunications Research Institute

(21) Appl. No.: 11/317,966

(22) Filed: Dec. 22, 2005

(30) Foreign Application Priority Data
Aug. 24, 2005 (KR) 10-2005-0078013

(51) Int. Cl. G06F 17/00; G07B 17/02

(52) U.S. Cl. 705/402; 700/225; 705/410

(57) ABSTRACT

Disclosed herein is a Radio Frequency Identification (RFID) tag for a postal logistics processing apparatus and a data configuration method thereof. The RFID tag for a postal logistics processing apparatus includes: a first area in which identification information of the tag is stored; a second area in which identification information for each service operation for processing a postal matter corresponding to the tag is stored; and a third area in which at least one of postal matter information and container information is stored, wherein the postal matter and the container correspond to the tag. Thus, by providing a configuration of an RFID tag and a configuration method of RFID tag information for a postal code using the RFID, it is possible to effectively and easily introduce an RFID technology in postal logistics environment.

### RELATED APPLICATION

The present application is based on, and claims priority from, Korean Application Number 2005-0078013, filed Aug. 24, 2005, the disclosure of which is hereby incorporated by reference herein in its entirety.

### BACKGROUND OF THE INVENTION

1. Field of the Invention

The present invention relates to a postal logistics processing apparatus, and more particularly to a Radio Frequency Identification (RFID) tag for a postal logistics processing apparatus, and a data configuration method thereof.

2. Description of the Related Art

With the advance of computer technologies, the world has changed remarkably, and the automation of the various fields of industry has been accomplished. However, the automation of postal matter handling and sorting operations in a post office has not yet been realized. That is, in order to handle and sort the postal matter, the post office employs a conventional method for locally collecting and sorting postal matters by people.

Particularly, in handling parcels, a postal employee performs a series of operations for individually scanning barcodes attached to each parcel when contracting received parcels, manually typing a zip code for sorting the parcels, scanning the barcodes attached to each parcel so as to re-contract the sorted parcels for each destination, and scanning the barcodes attached to each parcel in order to confirm the parcels for each postman with respect to the parcels which arrive at a collection and delivery post office.

Thus, in handling the parcels, much time and manpower is consumed. That is, since the conventional method for handling the parcels is based on the barcode, it takes a lot of time. For example, the required time is as follows: time for receiving the parcel, time for recording only a registration number, printing a barcode label, and attaching the barcode label to the parcel, time for individually scanning the barcode attached to the parcel and contracting the parcel with respect to the parcel and a container for the parcel, time for visually confirming the zip code recorded on the parcel, and for manually typing zip code of the recipient so as to sort the parcels having arrived at a mail center, time for scanning the barcodes attached to the parcels so as to contract the sorted parcels for each destination, and the like.

In addition, with respect to the parcels having arrived at a delivery post office, a postal employee in the delivery post office scans each barcode attached to the parcels so as to deliver the parcels for each postman. Thus, in handling the parcel using the barcode, it takes a lot of time and manual operations when receiving, manually typing and sorting, contracting and delivering the parcels.

Since the conventional apparatus and method for processing postal logistics is based on the barcode, much time and manpower is consumed when handling the postal logistics (particularly, a parcel processing service). In addition, errors may occur while processing the postal logistics.

The conventional apparatus and method for processing postal logistics degrades service quality and competitiveness with respect to the entire postal logistics regarding the parcel. In addition, in the case of processing the barcode-based postal logistics, it is difficult to accurately compare the real-parcel process with the parcel information process when receiving and sorting the parcel, when contracting the sorted parcels for each destination, and when delivering the parcels having arrived at the collection and delivery post office. Further, it may not be possible to monitor the received and delivered parcel and container for the parcel in real-time.

### SUMMARY OF THE INVENTION

Therefore, the present invention has been made in view of the above problems, and it is an object of the present invention to provide a radio frequency identification tag for a postal logistics processing apparatus, which is capable of issuing for each postal matter and for each container in order to automate postal logistics processing in an RFID-based postal logistics processing apparatus, and a data configuration method thereof.

In accordance with an aspect of the present invention, the above and other objects can be accomplished by the provision of a Radio Frequency Identification (RFID) tag for a postal logistics processing apparatus comprising: a first area in which identification information of the tag is stored; a second area in which identification information for each service operation for processing a postal matter corresponding to the tag is stored; and a third area in which at least one of postal matter information and container information is stored, wherein the postal matter and the container correspond to the tag.

Preferably, the second area includes: an office classification area in which office classification information with respect to each post office for processing corresponding service operations is stored; a service classification area in which service classification information for classifying corresponding services is stored; and an apparatus and item classification area in which the apparatus and item classification information for processing corresponding services is stored.

Preferably, any one among receiving post office information, mail center information, delivery post office information and container information is stored in the office classification area. Preferably, the service classification information with respect to any one among a receiving operation, an arrival operation, a sorting operation, a contracting operation, a sending operation, a delivery operation, a transportation operation and a tagging operation, is stored in the service classification area. Preferably, the apparatus and item classification information for classifying any one among a vehicle packing, a label issuing apparatus, typing, a sensing PC, a monitoring, an office nametag issuing apparatus, a container, a transportation vehicle, a sensing PDA and a delivery PDA is stored in the apparatus and item classification area.

In accordance with another aspect of the present invention, there is provided a method for the configuration of Radio Frequency Identification (RFID) tag information for a postal logistics processing apparatus comprising the steps of: a) generating a service code for a corresponding postal service when the postal service occurs; b) generating information of an object for performing the postal service; c) generating identification information for identifying a first RFID tag, wherein the first RFID tag stores the postal service code and the object information; and d) generating a second RFID tag, wherein the second RFID tag stores the identification information, the object information and the postal service code.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an overall concept of an apparatus for processing postal logistics to which the present invention is applied;

FIG. 2 is a view illustrating the configuration of an RFID tag defined by ISO/IEC and that of an RFID tag according to an embodiment of the present invention;

FIG. 3 is a view illustrating a data format with respect to RFID tag information for a container according to an embodiment of the present invention;

FIG. 4 is a view illustrating a data format with respect to RFID tag information for a postal matter according to an embodiment of the present invention;

FIG. 5 is a view illustrating a method for allowing a postal code according to an embodiment of the present invention;

FIG. 6 is a view illustrating an actually allowed postal code organization according to an embodiment of the present invention;

FIG. 7 is a view illustrating a process of constructing an RFID tag for a postal logistics processing apparatus according to an embodiment of the present invention; and

FIG. 8 is a view illustrating a postal logistics processing which is employing an RFID tag for a postal logistics processing apparatus according to an embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings.

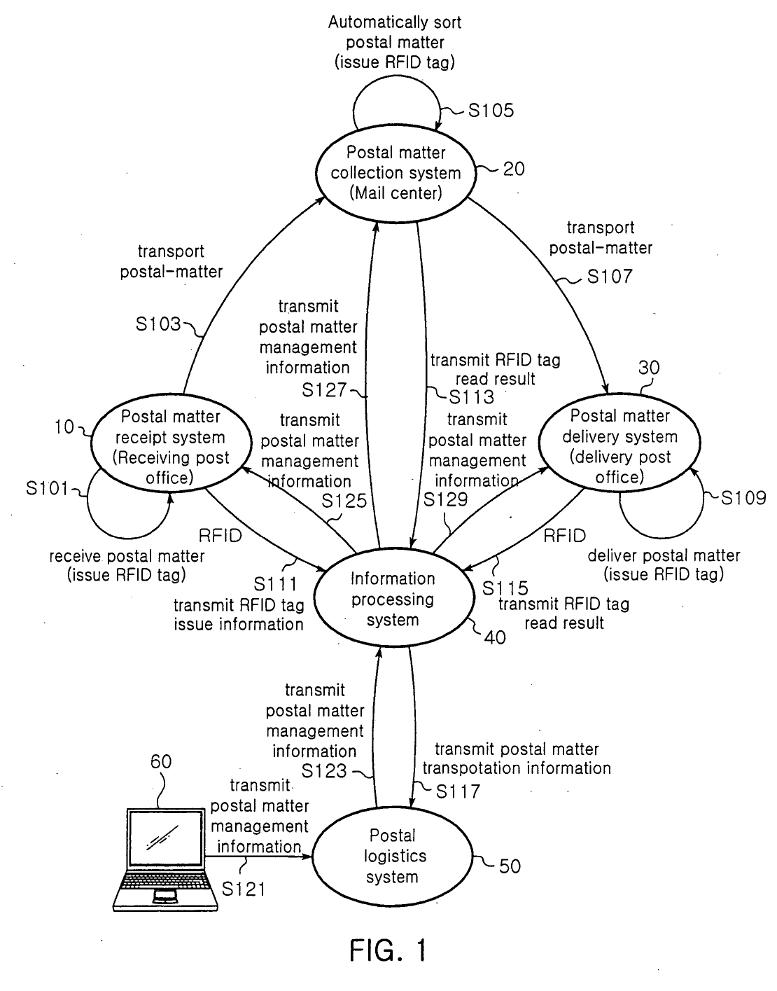

FIG. 1 is a view illustrating an overall concept of an apparatus for processing postal logistics to which the present invention is applied. Referring to FIG. 1, the postal logistics processing apparatus, to which the present invention is applied, includes a postal matter receipt system 10 arranged in a receiving post office which receives a postal matter to be transported; a postal matter collection system 20 arranged in a mail center which receives the postal matter transported from a plurality of receiving post offices and collects to sort the postal matter; a postal matter delivery system 30 arranged in a delivery post office which receives the postal matter transported from the mail center and delivers the postal matter to corresponding destinations; an information processing system 40 for managing the postal logistics-related information of the above systems 10, 20 and 30; and a postal logistics system 50 for managing the overall information of the postal logistics processing apparatus.

The postal logistics processing apparatus may further include a tagging system (not shown) for storing an identification number of a container with respect to the postal matter such as a parcel, etc. in an RFID tag when the supply of the container is requested. In addition, the postal logistics processing apparatus according to the embodiment of the present invention may further include a real-time monitoring system (not shown) for monitoring the processed status of the above systems in real-time. It is preferred that the real-time monitoring system receives the postal logistics processing-related information of the above systems from the information processing system 40, and displays the postal logistics processing-related information, wherein the real-time monitoring system (not shown) may be coupled with the above systems. That is, the real-time monitoring system (not shown) may be installed at any one of the receiving post office, the mail center and the delivery post office, and must be coupled with the postal matter receipt system 10, the postal matter collection system 20 and the postal matter delivery system 30.

The postal logistics processing apparatus having the above configuration operates as follows.

To begin with, when the postal matter (for example, a parcel) is received in the receiving post office, the postal matter receipt system 10 arranged in the receiving post office registers postal matter receipt information, and issues an RFID tag corresponding to the postal matter (S101). That is, the postal matter receipt system 10 registers the postal matter receipt information including a registration number of the received postal matter, a zip code of a destination, an identification number of a container and information for an office nametag, and then issues the RFID tag in which the postal matter receipt information is stored. At this time, it is preferred that the postal matter receipt system 10 generates the RFID tag, prints an RFID label corresponding to the RFID tag, and attaches the label to the corresponding postal matter.

Then, when the postal matter received through the postal matter receipt system 10 is transported to the mail center (S103), the postal matter collection system 20 arranged in the mail center reads the RFID tag for the postal matter, and automatically sorts the postal matter (S105). For example, the postal matter collection system 20 reads the zip code of a destination included in the RFID tag, and automatically sorts the postal matter for each destination on the basis of the zip code. In addition, the postal matter collection system 20 determines the destination of the postal matter on the basis of the read result, and transports the corresponding postal matter to a corresponding delivery post office (S107).

Meanwhile, the postal matter delivery system 30, which is arranged in the delivery post office which receives the postal matter, reads the RFID tag attached to the postal matter and delivers the postal matter to the corresponding destination of the postal matter (S109).

In the postal matter processing procedures, the above systems, that is, the postal matter receipt system 10, the postal matter collection system 20 and the postal matter delivery system 30 respectively transmit RFID tag information to the information processing system 40 in real-time, wherein the RFID tag information is issued or read when the postal matter is received or transported. For example, the postal matter receipt system 10 transmits RFID tag issue information to the information processing system 40 (S111), and the postal matter collection system 20 and the postal matter delivery system 30 respectively transmit an RFID tag reading result, that is, an RFID tag information, to the information processing system 40, wherein the RFID tag is attached to the postal matter which is transported to the mail center and the delivery post office (S113, S115). Then, the information processing system 40 confirms corresponding postal matter transportation information on the basis of the transmitted RFID tag information, and transmits the postal matter transportation information to the postal logistics system 50 (S117).

The postal logistics system 50, which receives the postal matter transportation information, displays the postal matter transportation information through a user terminal (for example, a PC, etc.), the real-time monitoring system, or a web server. Then, the user can confirm the postal matter transportation information in real-time. In addition, in a case where the real-time monitoring system (not shown) is included in the postal logistics processing apparatus, the information processing system 40 transmits the postal matter transportation information to the real-time monitoring system (not shown), and thereby the postal matter transportation information may be monitored in real-time at the place where the real-time monitoring system is arranged.

In addition, when postal matter management information is inputted from a user terminal 60 which is connected to the postal logistics system 50 via a dedicated line (S121), the postal logistics system 50 transmits the postal matter management information to the information processing system 40 (S123), and then the information processing system 40 transmits the postal matter management information to each corresponding system (for example, the postal matter receipt system 10, the postal matter collection system 20 or the postal matter delivery system 30 (S125, S127 and S129). In addition, it is preferred that the postal logistics system 50 transmits the postal matter transportation information, which is transported from each corresponding system, to each corresponding destination of the postal matters. At this time, in order to determine whether the postal matter is normally transported to the destination, the postal matter actually transported to the destination is compared with the postal matter transportation information transmitted through the postal logistics system 50.

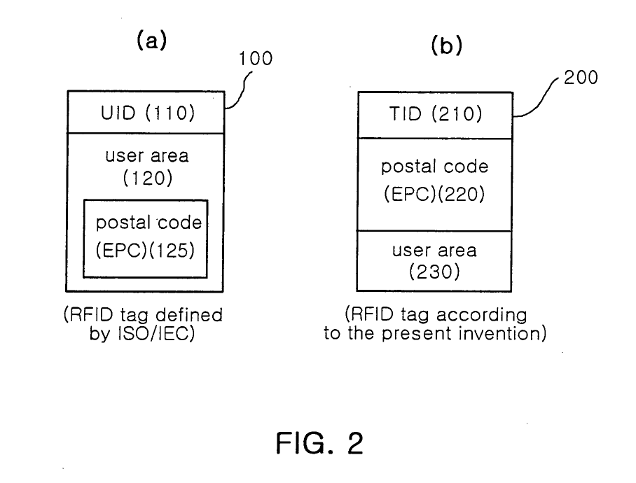

As noted above, the postal logistics processing system, to which the present invention is applied, receives the postal matter, issues the RFID tag corresponding to the postal matter, and automatically performs postal logistics processing by reading the issued RFID tag. At this time, configurations of the RFID tag information corresponding to the postal matter are illustrated as shown in FIGS. 2 to 6.

FIG. 2 is a view illustrating the configuration of an RFID tag defined by ISO/IEC and that of an RFID tag according to an embodiment of the present invention. In detail, (a) of FIG. 2 is a view illustrating the configuration of an RFID tag defined by ISO (International Organization for Standardization)/IEC (International Electrotechnical Commission). In addition, (b) of FIG. 2 is a view illustrating the configuration of an RFID tag according to an embodiment of the present invention.

Referring to (a) of FIG. 2, the RFID tag configuration 100 defined by the ISO/IEC as an international standard includes a User Identification (UID) area 110 and a user area 120, wherein the user area 120 includes an Electronic Product Code (EPC) 125, and a postal code is formed in the EPC. The international standard (ISO/IEC) defines only a basic form with respect to an organization of the RFID tag information and an organization of the EPC, and recommends that a real-object information organization or an EPC (for example, a postal code) organization, which is requested when applying the RFID technologies to various practical business circumstances, is defined according to a standpoint of each country or each company. However, it is the fact that the real-object information organization and the postal code organization for applying the RFID technologies in a postal logistics circumstance are not internationally defined yet.

Thus, as shown in (b) of FIG. 2, the present invention defines an RFID tag information organization, an EPC organization or a postal code organization which must be preceded in order to apply the RFID technologies to the postal logistics processing circumstance. Herein, the RFID tag information organization or the postal code (or EPC) organization is defined in consideration of a parcel processing and a container processing in the postal logistics circumstance.

Referring to (b) of FIG. 2, the RFID tag 200 according to an embodiment of the present invention, which is configured on the basis of the RFID tag 100 as shown in (a) of FIG. 2, includes a Tag Identification (TID) area 210 which is mapped into the UID area 110, an EPC area 220 which is mapped into the EOC area 125 in the user area 120, and a user area 230 which is mapped into a remaining area except for the EPC area 125 of the user area 120. Herein, a postal code area is formed in the EPC area 220.

In the TID area 210, identification information of the corresponding tag may be stored. In the EPC area 220, a postal code may be stored, wherein the postal code corresponds to various service operations for the postal matter processing which include from receiving of the postal matter to delivery of the postal matter.

In the user area 230, postal matter information and container information may be stored. For example, when the RFID corresponds to the postal matter, a registration number and a zip code may be stored in the user area 230, and when the RFID corresponds to the container, office nametag information and a container identification number may be stored in the user area 230.

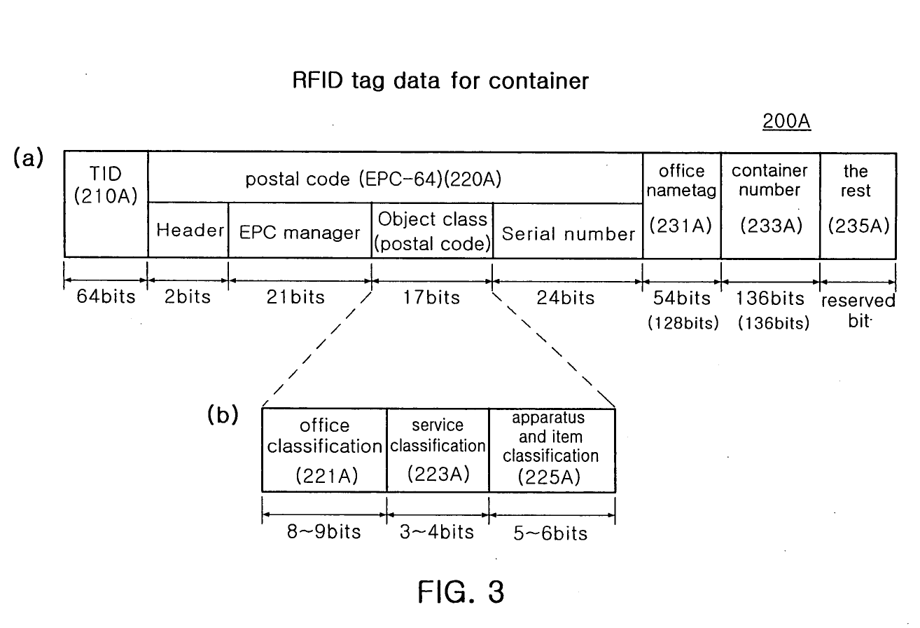

FIG. 3 is a view illustrating a data format with respect to RFID tag information for a container according to an embodiment of the present invention.

Referring to (a) of FIG. 3, the RFID tag 200A for the container according to the embodiment of the present invention, which is applied to the container such as a pallet, a postal box, or the like, includes a UID or TID area 210A, an EPC area 220A corresponding to the EPC, an office nametag storing area 231A, a container number storing area 233A, and the rest area 235A. Herein, it is preferred that, 54 bits are allocated to the office nametag storing area 231A when the RFID tag employs Ultra High Frequency (UHF), and 128 bits are allocated to the office nametag storing area 231A when the RFID tag employs High Frequency (HF). In addition, it is preferred that, 136 bits are commonly allocated to the container number storing area 233A when the RFID tag employs either UHF or HF.

Meanwhile, as shown in (b) of FIG. 3, the postal code, which corresponds to various service operations for the postal matter processing, is formed using an object class area of 17 bits in the EPC area 220A of 64 bits.

That is, the object class area, in which the postal code with respect to various service operations is stored, includes an office classification area 221A of 8˜9 bits for classifying post offices in all the country, a service classification area 223A of 3˜4 bits for classifying service types, and an apparatus and item classification area 225A of 5˜6 bits for classifying apparatuses or items for use.

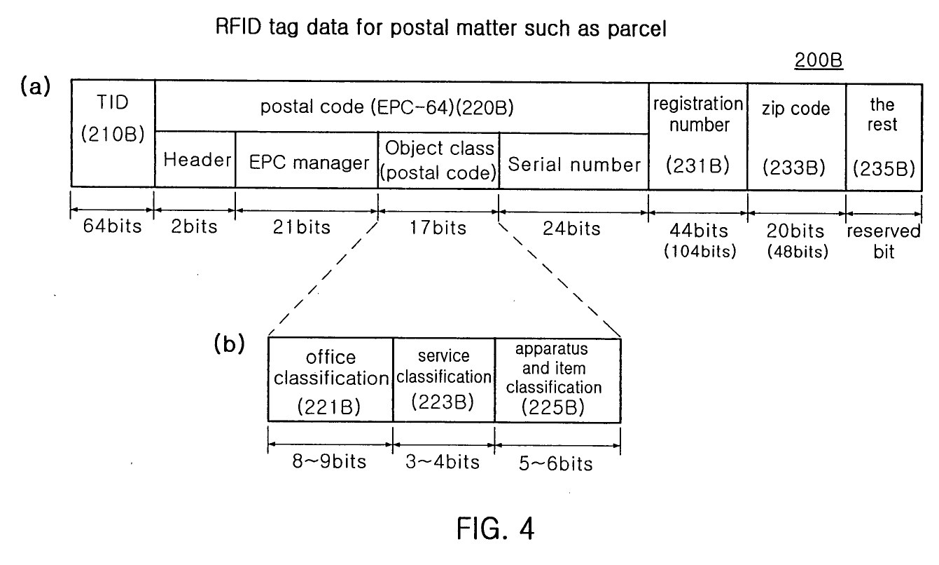

FIG. 4 is a view illustrating a data format with respect to RFID tag information for a postal matter according to an embodiment of the present invention.

Referring to (a) of FIG. 4, the RFID tag 200B for the postal matter according to the embodiment of the present invention includes a UID or TID area 210B, an EPC area 220B corresponding to the EPC, an registration number storing area 231B, a zip code storing area 233B, and the rest area 235B. Herein, it is preferred that, 44 bits are allocated to the registration number storing area 231B when the RFID tag employs Ultra High Frequency (UHF), and 104 bits are allocated to the registration number storing area 231B when the RFID tag employs High Frequency (HF). In addition, it is preferred that, 20 bits are allocated to the zip code storing area 233B when the RFID tag employs UHF, and 48 bits are allocated to the zip code storing area 233B when the RFID tag employs HF.

Meanwhile, as shown in (b) of FIG. 4, the postal code, which corresponds to various service operations for the postal matter processing, is formed using an object class area of 17 bits in the EPC area 220B of 64 bits.

That is, the object class area, in which the postal code with respect to various service operations is stored, includes an office classification area 221B of 8˜9 bits for classifying post offices in all the country, a service classification area 223B of 3˜4 bits for classifying service types, and an apparatus and item classification area 225B of 5˜6 bits for classifying apparatuses or items for use.

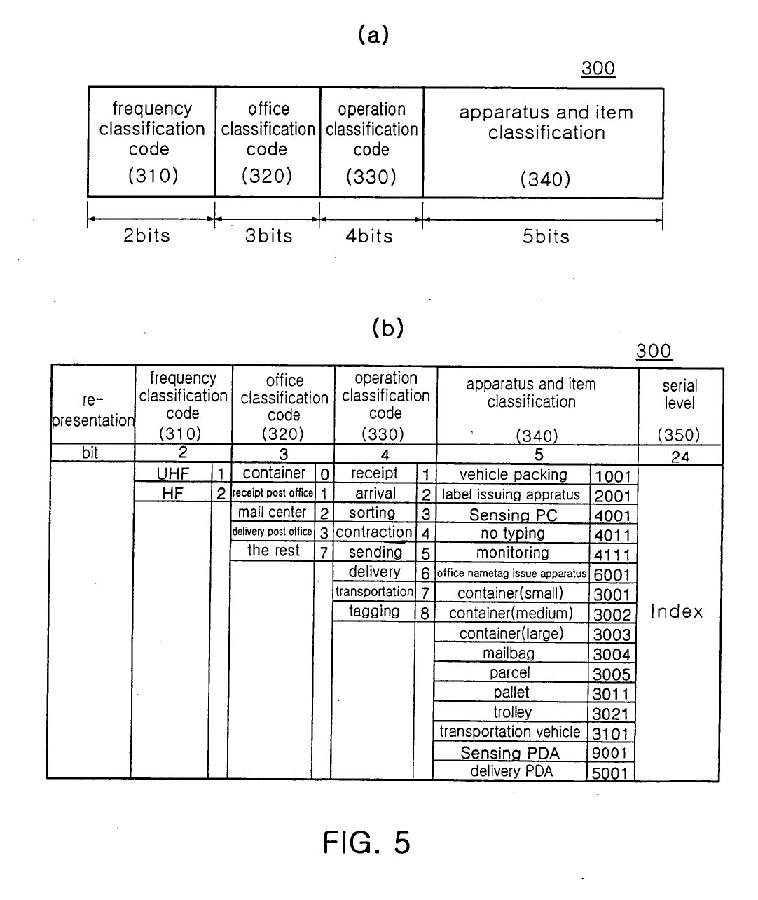

FIG. 5 is a view illustrating a method for allowing a postal code corresponding to an EPC in an RFID tag according to an embodiment of the present invention. Particularly, FIG. 5 is a view illustrating a postal code and a method for allowing the postal code for representing a code for a postal service.

To begin with, (a) of FIG. 5 is a view illustrating the postal code area 300 for representing the postal service code. Referring to (a) of FIG. 5, the postal code area 300 includes a frequency classification code 310 of 2 bits, an office classification code area 320 of 3 bits, a service classification code area 330 of 4 bits, and an apparatus/item classification code area 340 of 5 bits.

Meanwhile, (b) of FIG. 5 is a view illustrating corresponding information stored in each code area of (a) of FIG. 5.

Referring to (b) of FIG. 5, in the frequency classification code area 310, information for classifying an UHF type code or an HF type code is stored. For example, when ‘1’ is stored in the frequency classification code area 310, the corresponding code represents the UHF type code, and when ‘2’ is stored in the frequency classification code area 310, the corresponding code represents the HF type code.

In the office classification code area 320, information for classifying whether the corresponding code is a container code, or when the corresponding code is not the container code, classifying whether the corresponding code is generated in any office among the receiving post office, the mail center and the delivery post office is stored. For example, when ‘0’ is stored in the office classification code area 320, the corresponding code represents identification information for the container, and when ‘1’ is stored in the office classification code area 320, the corresponding code represents identification information for the postal matter received in the receiving post office. In addition, when ‘2’ is stored in the office classification code area 320, the corresponding code represents identification information for the postal matter collected in the mail center, and when ‘3’ is stored in the office classification code area 320, the corresponding code represents identification information for the postal matter arrived at the delivery post office. In addition, when ‘7’ is stored in the office classification code area 320, the corresponding code represents ‘the rest’ information to which the corresponding code is not additionally allocated.

In the service classification code area 330, information for classifying a service with respect to the corresponding code is stored. For example, when ‘1’ is stored in the service classification code area 330, the corresponding code represents a receiving service, and when ‘2’ is stored in the service classification code area 330, the corresponding code represents an arrival service. In addition, when ‘3’ is stored in the service classification code area 330, the corresponding code represents a classification service, and when ‘4’ is stored in the service classification code area 330, the corresponding code represents a contraction service. In addition, when ‘5’ is stored in the service classification code area 330, the corresponding code represents a sending service, and when ‘6’ is stored in the service classification code area 330, the corresponding code represents a delivery service. In addition, when ‘7’ is stored in the service classification code area 330, the corresponding code represents a transportation service, and when ‘8’ is stored in the service classification code area 330, the corresponding code represents a tagging service.

In the apparatus/item classification code area 340, information for classifying the apparatus/item corresponding to the code (that is, the service) is stored. For example, in order to classify each object in the postal matter processing, 1000 is allocated to a vehicle packaging, and 2001 is allocated to a label issuing apparatus. In addition, 4001 is allocated to a sensing PC, and 4011 is allocated to a typing processing. In addition, 4111 is allocated to a monitoring, and 6001 is allocated to an office nametag issuing apparatus. In addition, 3001 is allocated to a small container, 3002 is allocated to a medium container, and 3003 is allocated to a large container. In addition, 3004 is allocated to a mailbag, 3005 is allocated to a parcel, and 3011 is allocated to a pallet. In addition, 3021 is allocated to a trolley, 3101 is allocated to a transportation vehicle, 9001 is allocated to a sensing PDA, and 5001 is allocated to a delivery PDA.

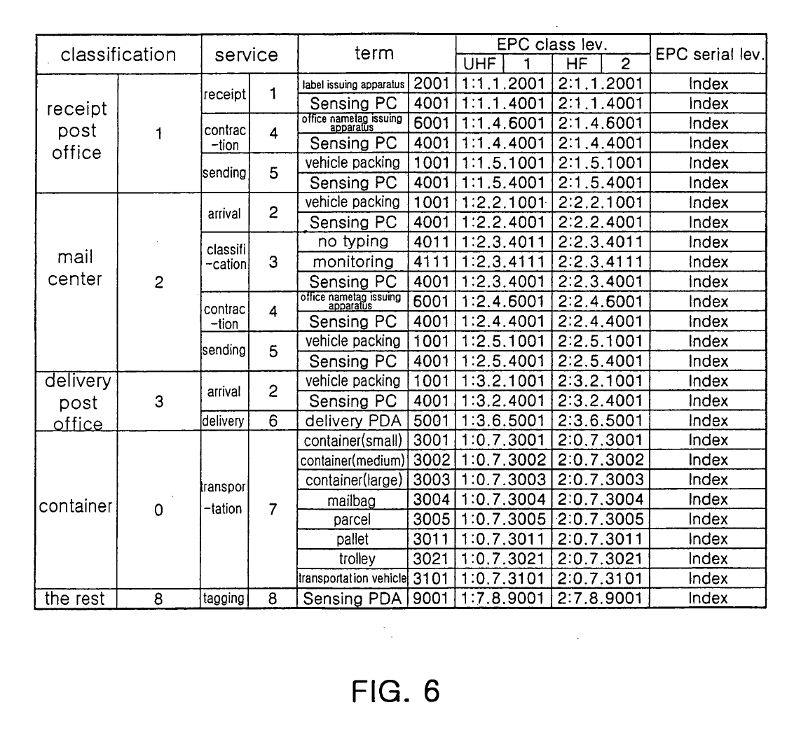

FIG. 6 is a view illustrating an actually allowed postal code organization corresponding to an EPC according to an embodiment of the present invention. Referring to FIG. 6, in a case where a receiving label issuing apparatus of the receiving post office with an UHF type RFID in the postal code organization, a postal code object value is ‘1:1.1.2001’. In addition, in a case where a receiving label issuing apparatus of the receiving post office with an HF type RFID in the postal code organization, a postal code object value is ‘2:1.1.2001’. At this time, ‘1’ and ‘2’ of the first part in the code represents the frequency classification code. That is, ‘1’ or ‘2’ represents whether the corresponding code is the UHF type or HF type. Meanwhile, a first ‘1’ after the colon (:) represents the receiving post office among the office classification code. A second ‘1’ after the colon (:) represents the receipt service among the service classification code. In addition, ‘2001’ of the end part represents the label issuing apparatus among the apparatus/item classification code. Thus, ‘1:1.1.2001’ represents a label issuing apparatus for the receiving service of the receiving post office with the UHF type code. Similarly, ‘2:1.1.2001’ represents a label issuing apparatus for the receiving service of the receiving post office with the HF type code.

On the other hand, ‘1:3.6.5001’ represents a delivery PDA (5001) for the delivery service (6) of the delivery post office (3) with the UHF type code (1), and ‘2:3.6.5001’ represents a delivery PDA (5001) for the delivery service (6) of the delivery post office (3) with the HF type code (2).

The postal code organization with respect to the other apparatuses and items is as shown in FIG. 6.

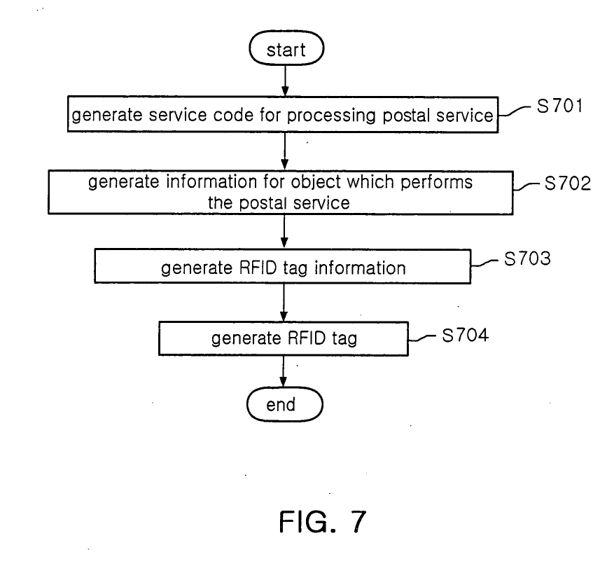

FIG. 7 is a view illustrating a process of constructing an RFID tag for a postal logistics processing apparatus according to an embodiment of the present invention.

Referring to FIG. 7, in order to the RFID tag for the postal logistics processing apparatus according to an embodiment of the present invention, to begin with, the postal logistics processing apparatus generates a service code for processing a postal service when the postal service occurs (S701). Herein, the postal service to be processed may include a receiving service, an arrival service, a classification service, a contraction service, a sending service, a delivery service, a transportation service and a tagging service, etc. Thus, in Step S701 of generating the service code for postal service processing, it is preferred that the postal logistics processing apparatus generates service classification information for any one postal service among the receiving service, the arrival service, the classification service, the contraction service, the sending service, the delivery service, the transportation service and the tagging service.

In addition, the service code for processing the postal service may further post office classification information and container classification information to more effectively perform the postal service. Thus, in Step S701 of generating the service code for the postal service processing, it is preferred that the postal logistics processing apparatus generates the service code including information for any one of the receiving post office, the mail center and the delivery post office and information for the container.

In addition, the service code for processing the postal service may further include information for classifying the apparatus/item such as a vehicle packing, a label issuing apparatus, typing, a sensing PC, a monitoring, an office nametag issuing apparatus, a container, a transportation vehicle, a sensing PDA and a delivery PDA. Thus, in Step S701 of generating the service code for the postal service processing, it is preferred that the postal logistics processing apparatus generates the service code including information for any one apparatus/item of the vehicle packing, the label issuing apparatus, the typing, the sensing PC, the monitoring, the office nametag issuing apparatus, the container, the transportation vehicle, the sensing PDA and the delivery PDA.

Next, the postal logistics processing apparatus generates information for an object which performs the postal service (S703). Herein, the object which performs the postal service may include a postal matter or a container for transporting the postal matter, wherein the container includes a pallet, a mail box, or the like. Thus, in Step S703, when the object is the container, the postal logistics processing apparatus generates office nametag information the corresponding container and a container number. In addition, when the object is a postal matter, the postal logistics processing apparatus generates a registration number and a zip code corresponding to the postal matter.

Next, the postal logistics processing apparatus generates tag identification (TID) information for identifying the RFID tag, wherein the tag identification (TID) information includes the service code and the object information (S705).

Lastly, the postal logistics processing apparatus generates the RFID tag, wherein the RFID tag stores the identification information, the service code and the object information (S707).

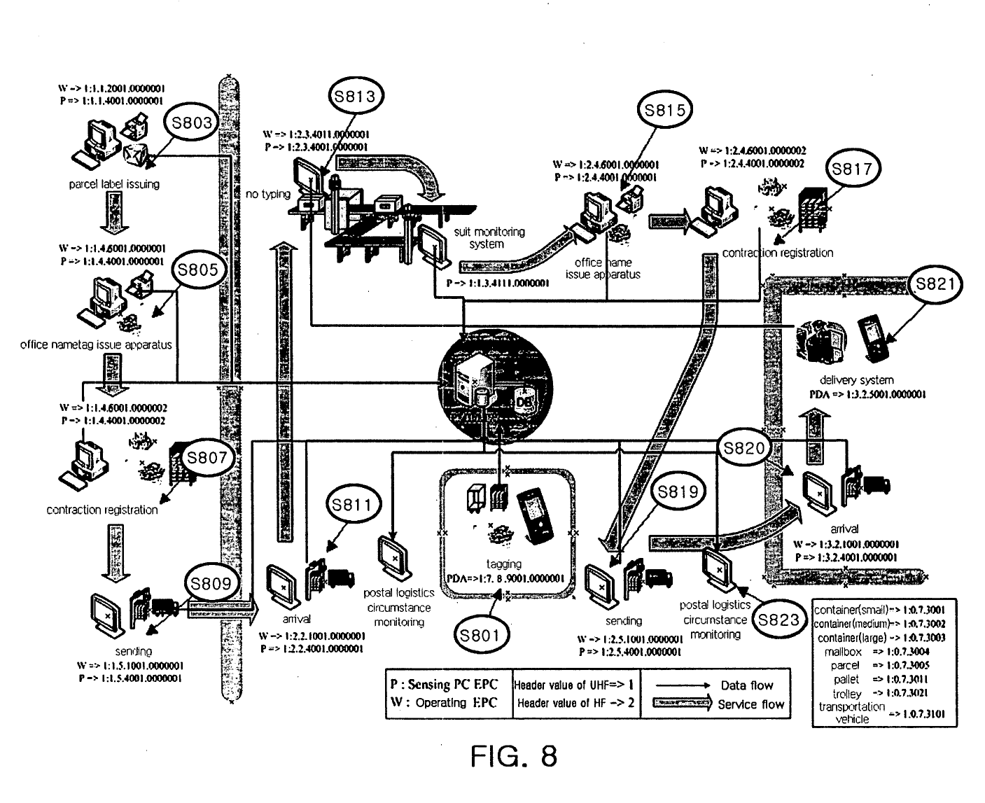

FIG. 8 is a view illustrating a postal logistics processing which is employing an RFID tag for a postal logistics processing apparatus according to an embodiment of the present invention.

FIG. 8 represents a process for handling a parcel and a process for collecting and paying the container for each postal service process and on the basis of a postal code object value which is allocated to the parcel, the container and the like, in order to apply RDID technologies in postal logistics environment.

To begin with, in order to perform tagging operation for the container, when the corresponding code is the UHF type, the postal logistics processing apparatus generates a combined value ‘1:7.8.9001.0000001’ which is a mixed value of a postal code object value ‘1:7.8.9001’ and a container number ‘0000001’ (S801).

Next, as a parcel label issuing process when the postal matter is a parcel, the postal logistics processing apparatus generates a combined value ‘1:1.1.2001.0000001’ which is a mixed value of a postal code object value ‘1:1.1.2001’ and a parcel number ‘0000001’, and allocates a value ‘1:1.1.4001.0000001’ to a parcel receiving apparatus in order to receive the parcel (S803).

Next, as an office nametag issuing process for setting mother-child relation between the received parcel and the container, the postal logistics processing apparatus generates a combined value ‘1:1.4.6001.0000001’ which is a mixed value of a postal code object value ‘1:1.4.6001’ and a number ‘0000001’, and allocates a value ‘1:1.4.4001.0000001’ to an office nametag issuing apparatus (S805).

Then, as a contracting process of the received parcel and the container, the postal logistics processing apparatus generates a combined value ‘1:1.4.6001.0000002’ which is a mixed value of a postal code object value ‘1:1.4.6001’ and a number ‘0000002’, and allocates a value ‘1:1.4.4001.0000002’ to a contracting apparatus (S807).

Then, as a sending process of the received parcel and the container, the postal logistics processing apparatus generates a combined value ‘1:1.5.1001.0000001’ which is a mixed value of a postal code object value ‘1:1.5.1001’ and a number ‘0000001’, and allocates a value ‘1:1.5.4001.0000001’ to a sending apparatus (S809).

Next, as an arrival processing process of the parcel and the container, the postal logistics processing apparatus generates a combined value ‘1:2.2.1001.0000001’ which is a mixed value of a postal code object value ‘1:2.2.1001’ and a number ‘0000001’, and allocates a value ‘1:2.2.4001.0000001’ to an arrival processing apparatus of the mail center (S811).

Then, as a zip code no-typed parcel automatic classification process, the postal logistics processing apparatus generates a combined value ‘1:2.3.4011.0000001’ which is a mixed value of a postal code object value ‘1:2.3.4011’ and a number ‘0000001’, and allocates a value ‘1:2.2.4001.0000001’ to a parcel classification apparatus (S813).

Next, as an office nametag issuing process of the mail center for setting mother-child relation between the classified parcel and the container, the postal logistics processing apparatus generates a combined value ‘1:2.4.6001.0000001’ which is a mixed value of a postal code object value ‘1:2.4.6001’ and a number ‘0000001’, and allocates a value ‘1:2.2.4001.0000001’ to an office nametag issuing apparatus the mail center (S815).

In addition, as a contracting process of the classified parcel and the container, the postal logistics processing apparatus generates a combined value ‘1:2.4.6001.0000002’ which is a mixed value of a postal code object value ‘1:2.4.6001’ and a number ‘0000002’, and allocates a value ‘1:2.4.4001.0000002’ to a classified parcel contracting apparatus (S817).

Then, as a sending process of the classified parcel and the container, the postal logistics processing apparatus generates a combined value ‘1:2.5.1001.0000001’ which is a mixed value of a postal code object value ‘1:2.5.1001’ and a number ‘0000001’, and allocates a value ‘1:2.5.4001.0000001’ to a sending processing apparatus of the mail center (S819).

Then, as an arrival processing process of the delivery parcel and the container, the postal logistics processing apparatus generates a combined value ‘1:3.2.1001.0000001’ which is a mixed value of a postal code object value ‘1:3.2.1001’ and a number ‘0000001’, and allocates a value ‘1:3.2.4001.0000001’ to an arrival processing apparatus of the delivery post office (S820).

Next, as a parcel delivery process, the postal logistics processing apparatus generates a combined value ‘1:3.2.5001.0000001’ which is a mixed value of a postal code object value ‘1:3.2.5001’ and a number ‘0000001’ (S821).

In addition, a postal logistics circumstance monitoring process for knowing of their status in real-time and performing statistics management with respect to the parcel and the container is further performed (S823).

As apparent from the above description, the present invention provides a radio frequency identification tag for a postal logistics processing apparatus and a data configuration method thereof, wherein, when applying a Radio Frequency Identification (RFID) tag in performing a postal logistics (particularly, a parcel handling process), by providing a configuration of an RFID tag and a configuration method of RFID tag information for a postal code using the RFID defined by ISO/IEC, it is possible to effectively and easily introduce an RFID technology in postal logistics environment. In addition, the RFID tag configuration method and the postal code allowance method, which are applied to a parcel or a container defined in postal logistics environment, can be applied to a home delivery service in general distribution environment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Radio Frequency Identification (RFID) tag for a postal logistics processing apparatus comprising:
a first area in which identification information of the tag is stored;
a second area in which identification information for each service operation for processing a postal matter corresponding to the tag is stored; and
a third area in which at least one of postal matter information and container information is stored, wherein the postal matter and the container correspond to the tag.

2. The RFID tag as set forth in claim 1, wherein, frequency classification information for identifying type information of the corresponding tag is stored in the first area.

3. The RFID tag as set forth in claim 2, wherein the second area comprises:
an office classification area in which office classification information with respect to each post office for processing corresponding service operations is stored;
a service classification area in which service classification information for classifying corresponding services is stored; and
an apparatus and item classification area in which apparatus and item classification information for processing corresponding services is stored.

4. The RFID tag as set forth in claim 3, wherein, any one among receiving post office information, mail center information, delivery post office information and container information is stored in the office classification area.

5. The RFID tag as set forth in claim 3, wherein, the service classification information with respect to any one among a receiving operation, an arrival operation, a sorting operation, a contracting operation, a sending operation, a delivery operation, a transportation operation and a tagging operation, is stored in the service classification area.

6. The RFID tag as set forth in claim 3, wherein, the apparatus and item classification information for classifying any one among a vehicle packing, a label issuing apparatus, typing, a sensing PC, a monitoring, an office nametag issuing apparatus, a container, a transportation vehicle, a sensing PDA and a delivery PDA is stored in the apparatus and item classification area.

7. The RFID tag as set forth in claim 1, wherein a container number and office nametag information of the container corresponding to the tag are stored in the third area.

8. The RFID tag as set forth in claim 1, wherein a registration number and a zip code of the postal matter corresponding to the tag are stored in the third area.

9. A method for the configuration of Radio Frequency Identification (RFID) tag information for a postal logistics processing apparatus comprising the steps of:
a) generating a service code for a corresponding postal service when the postal service occurs;
b) generating information of an object for performing the postal service;
c) generating identification information for identifying a first RFID tag, wherein the first RFID tag stores the postal service code and the object information; and
d) generating a second RFID tag, wherein the second RFID tag stores the identification information, the object information and the postal service code.

10. The method as set forth in claim 9, wherein said step a) generates the postal service code which includes service classification information for classifying any one service among a receipt service, an arrival service, a contraction service, a sending service, a delivery service, a transportation service and a tagging service.

11. The method as set forth in claim 9, wherein said step a) generates the postal service code which includes office classification information for classifying any one among a receiving post office, a mail center and a delivery post office, and container information.

12. The method as set forth in claim 9, wherein said step a) generates the postal service code which includes an apparatus/item classification information for classifying any one among a vehicle packing, a label issuing apparatus, typing, a sensing PC, a monitoring, an office nametag issuing apparatus, a container, a transportation vehicle, a sensing PDA and a delivery PDA.

13. The method as set forth in claim 9, wherein said step b) generates a container number and office nametag information of a corresponding container when the object is the container.

14. The method as set forth in claim 9, wherein said step b) generates a registration number and a zip code of a postal matter when the object is the postal matter.
